(19) United States
(12) Patent Application Publication
(10) Pub. No.: US 2007/0030522 A1
(43) Pub. Date: Feb. 8, 2007

(54) Image processing apparatus and image processing method

(75) Inventors: Masaaki Sasaki, Hachioji-shi (JP); Akira Hamada, Sagamihara-shi (JP); Shinichi Matsui, Hamura-shi (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: Casio Computer Co., Ltd., Tokyo (JP)

(21) Appl. No.: 11/498,468

(22) Filed: Aug. 3, 2006

(30) Foreign Application Priority Data
Aug. 8, 2005 (JP) 2005-229811

(51) Int. Cl. G06K 15/02; G06F 15/00

(52) U.S. Cl. 358/302; 358/471; 358/1.2

(57) ABSTRACT

An image processing method according to the invention includes: an image read step for reading an image produced by a color imaging device (S1); a first coordinate transformation step for rotating the image read by the image read step by 45 degrees in a predetermined direction to generate a rotated picture based on a new coordinate system (S2); an image processing step for performing image processing to the rotated picture (S3); and a second coordinate transformation step for rotating the image after the image processing by 45 degrees in the reverse direction of the predetermined direction to reflect the image processing to the image in the original coordinate system (S4). This method enables required image processing without the need for interpolation processing of information missing pixels contained in an image generated by a color imaging device of a single-plate type.

### CROSS-REFERENCE TO RELATED APPLICATION

This application is based upon and claims the benefit of priority from the prior Japanese Patent Application No. 2005-229811, filed 8 Aug. 2005, the entire contents of which are incorporated herein by reference.

### BACKGROUND OF THE INVENTION

1. Field of the Invention

The present invention relates to an image processing device and an image processing method applied for processing and synthesizing images produced by a color imaging device of a single-plate type.

2. Description of the Related Art

When imaging sensitivity of a digital camera or the like (signal amplification gain of an imaging device) is increased, although shooting performance improves for a dark subject such as a night view, noise sometimes appears on an image, making the image unsightly. Filtering processing of images is one of the noise reduction measures. However, with this processing, some of the image information (high-frequency components) is lost together with noise, which is likely to cause deterioration of image quality.

To address this, an art to reduce noise by synthesizing a plurality of images that are shot consecutively (hereinafter referred to as conventional prior art) is described in Japanese Laid-Open (Kokai) Patent Application No. 2004-357040. This is based on the findings that when an image is synthesized from a plurality of images that are shot of a same subject consecutively by overlapping them, random noise components are averaged, while the subject section of the synthesized image increases in proportion to the number of images. This enables reducing noise to enhance imaging sensitivity without losing high-frequency components of the image and enhancing shooting performance of a dark subject.

Meanwhile since a shutter speed in shooting a dark subject is generally low, a camera shake or subject blur may occur. In addition, in the case where shooting a same subject consecutively, there may be a minute shift in composition (framing) at each shooting point.

According merely “synthesizing an image from a plurality of images that are shot of a same subject consecutively by overlapping them” is not sufficient, and there is a need to improve overlapping accuracy of each section of the images. That is, it is necessary to calculate (estimate) optical flow between images that are subject to image synthesis and accurately perform positioning of each section of the image (e.g., tracking processing) based on the calculated optical flow.

FIG. 8 is an explanation view of the optical flow estimation. The optical flow estimation can be performed by a template matching method (also referred to as a block matching method) described in Japanese Laid-Open (Kokai) Patent Publication No. 2002-369222. As shown in the diagram, the template matching method refers to a method for searching a block 3 in a reference image which most resembles a small block 2 (a block of a size approximately 16×16 pixels) in an image 1 for which a motion vector is to be estimated. A search range 4 has a size, for example, of approximately ±16 pixels in the vertical direction and approximately ±16 pixels in the horizontal direction of the small block 2. Search of all pixels (all search) is performed within the search range 4 , and a motion vector 5 for minimizing a predicted error is determined.

However, a problem as below occurs when the conventional prior art as described above is applied to an imaging apparatus such as a digital camera with a color imaging device of a single-plate type.

FIG. 9 is a view showing one CCD 6 and a color filter 7 attached to the CCD 6. Each grid of the CCD 6 represents one pixel containing one photoelectric conversion element 8, and each pixel corresponds one-to-one with the grid of the color filter 7. Each grid of the color filter 7 has a specific color. Various types of color filters are used depending on choice of color and layout.

FIGS. 10A and 10B show the principle of the color filter 7 which was invented by B. E. Bayer and referred to as Bayer type (hereinafter referred to as Bayer-type filter). The Bayer-type filter is widely used because of its good S/N balance of a color signal and brightness signal and because of good color reproducibility without depending on brightness of a subject.

In the Bayer-type filter as shown, Y denotes a filter for acquiring brightness information, and C1 and C2 denote filters for acquiring color information. A Bayer-filter has an arrangement in which the filters Y are arranged in a checkered pattern as shown in FIG. 10A, the filters C1 are arranged in the gaps on odd-number lines, and the filters C2 are arranged in the gaps on even-number lines.

FIG. 11 is a configuration of an actual color filter that uses a Bayer method, where R denotes a red filter, G denotes a green filter and B denotes a blue filter. Red (R), green (G) and blue (B) are primary colors of light. Particularly, since green well represents brightness of the subject, a filter G is used as one for acquiring brightness information. In other words, the filter G corresponds to the filter Y shown in FIGS. 10A and 10B, and the filter R and the filter B correspond to the filters C₁ and C₂ shown in FIGS. 10A and 10B.

FIG. 12 is a diagram created by taking out the filters G only. As shown in the diagram, the image G is configured by pixel signals G that are arranged in a checked pattern in which an ‘information missing pixel’ is interposed between two pixel signals G in the vertical and horizontal directions, respectively.

In the case where optical flow estimation as described above is to be performed for the image G containing the information missing pixels, at first, interpolation of the information on the information missing pixels, that is, for example, an average value of four pixels (pixels G) surrounding the subject information missing pixel, is determined. Next, processing for setting the average value as the information on the information missing pixel is performed for all information missing pixels to generate an interpolated image. Following this, the optical flow estimation as described above is performed for the interpolated image.

By doing this, however, load on the interpolation processing causes a delay in an operation of an imaging apparatus handling, in particular, high-definition and high-resolution images. This leads to a problem, for example, that the number of shooting decreases during the continuous shooting.

Therefore, the object of the present invention is to provide an image processing apparatus and image processing method capable of performing required processing as it is to an original image from which information missing pixels are excluded, and reducing the load in image processing, thereby improving the operational speed.

### SUMMARY OF THE INVENTION

In order to achieve the foregoing object, the present invention provides an image processing apparatus comprising: an image read section for reading an image produced by a color imaging device; a first coordinate transformation section for rotating the image read by the image read section by 45 degrees in a predetermined direction to generate a rotated picture based on a new coordinate system; an image processing section for performing image processing of the rotated picture; and a second coordinate transformation section for rotating the image after the image processing by 45 degrees in the reverse direction of the predetermined direction to reflect the image processing to the image in the original coordinate system.

The above and further objects and novel features of the present invention will more fully appear from the following detailed description when the same is read in conjunction with the accompanying drawings. It is to be expressly understood, however, that the drawings are for the purpose of illustration only and are not intended as a definition of the limits of the invention.

### BRIEF DESCRIPTION OF THE DRAWINGS

FIG. 1 shows an overall configuration of an embodiment of the present invention;

FIG. 2 is a schematic view of an image G developed in a memory G 20;

FIG. 3 is a diagram of a rotated picture generated by rotating the image G by 45 degrees in a predetermined direction (clockwise direction in the diagram);

FIG. 4 is a diagram of the rotated picture overlapped with coordinate axes before rotation;

FIG. 5 is a schematic view of the rotated picture stored in the memory for rotated picture 22;

FIG. 6 is a conceptual diagram of optical flow estimation targeted to the rotated picture;

FIG. 7 is a diagram of an operation flowchart including the optical flow estimation processing;

FIG. 8 is an explanatory view of the optical flow estimation;

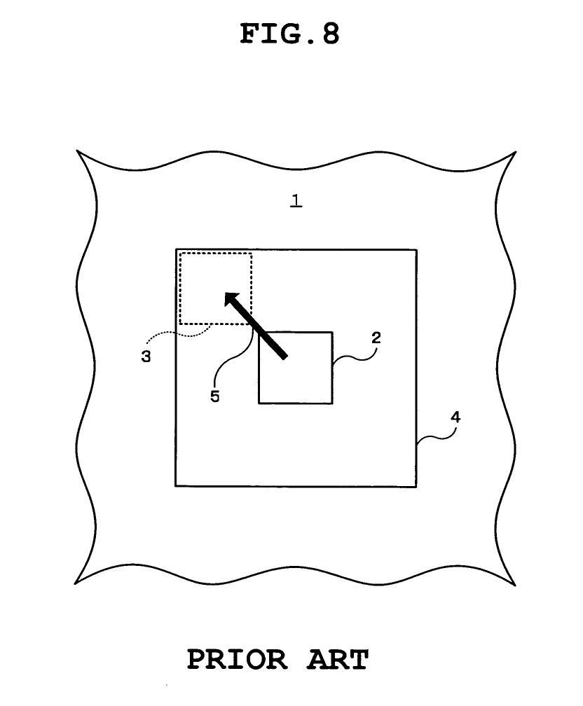

FIG. 9 is a view showing one CCD 6 and a color filter 7 attached to the CCD 6;

FIGS. 10A and 10B show the principle of a Bayer-type filter;

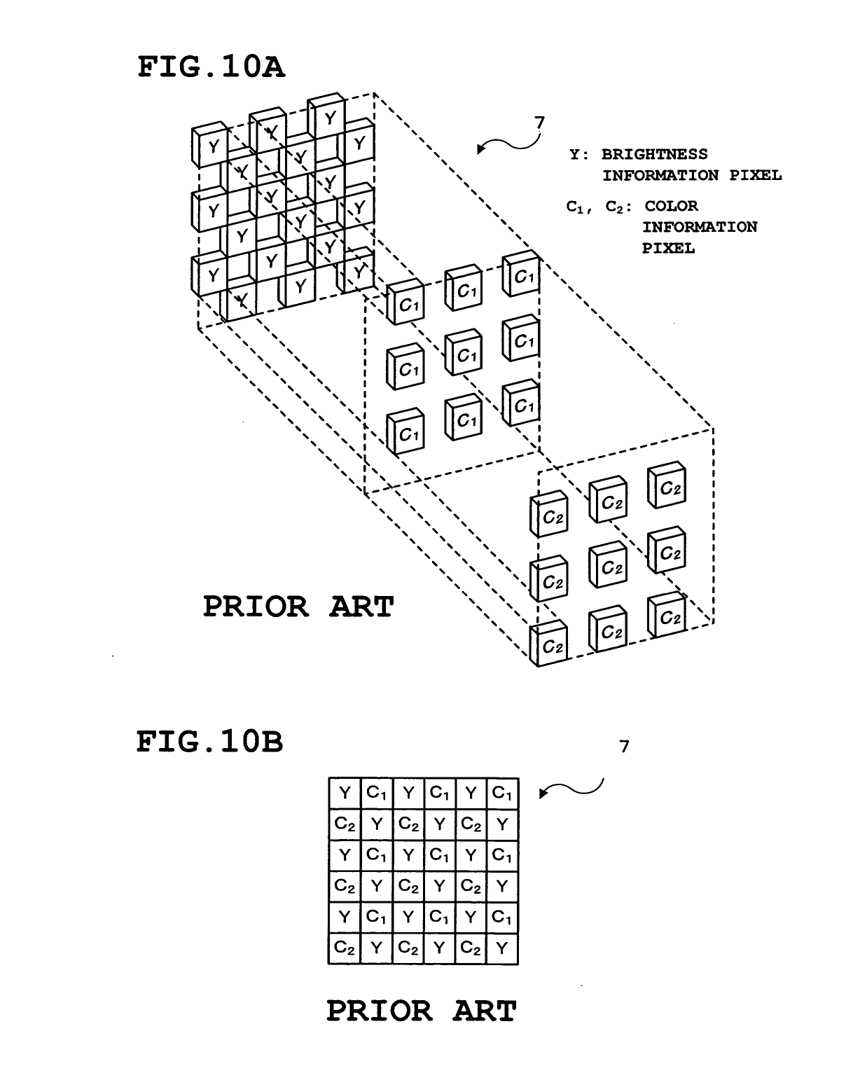

FIG. 11 is a configuration of a actual color filter that uses a Bayer method; and

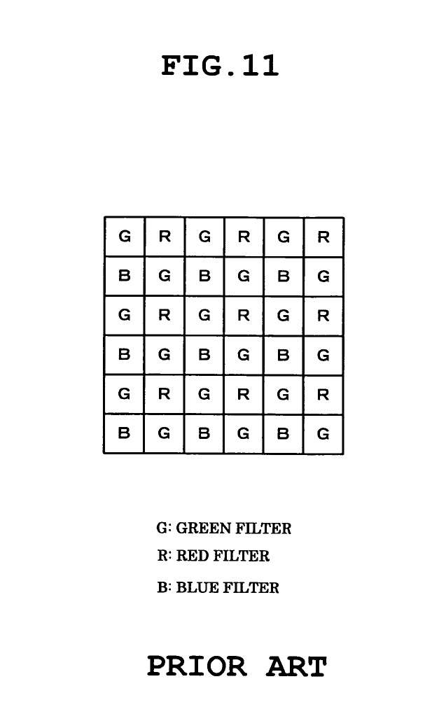

FIG. 12 is a diagram showing the image G configured by pixel signals G.

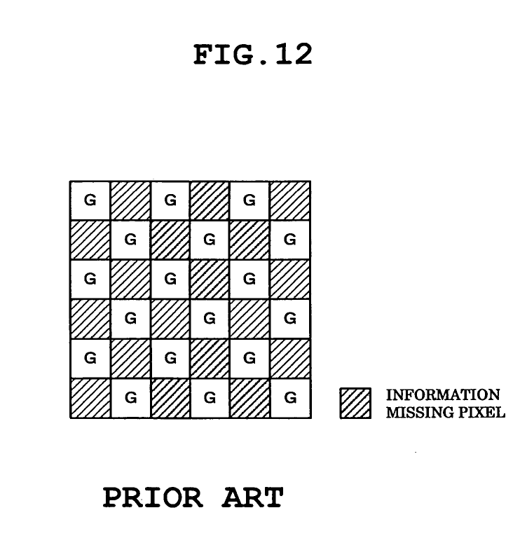

### DETAILED DESCRIPTION OF THE PREFERRED EMBODIMENTS

The present invention will hereinafter be described in detail with reference to the preferred embodiments shown in the accompanying drawings. It is apparent that various detailed specifications or examples as well as illustration of numerical figures, texts and other symbols in the following description are merely references for clarifying the concept of the present invention, and that the concept of the present invention is not limited by all or a part of these. In addition, a detailed explanation shall be omitted regarding a known method, a known procedure, known architecture, a known circuit configuration and the like (hereinafter referred to as ‘known matters’), which is also to be intended to clarify the explanation and not to exclude all or apart of these known matters intentionally. Since such known matters are known to those skilled in the art at the time of application of the present invention, they are as a matter of course included in the following description.

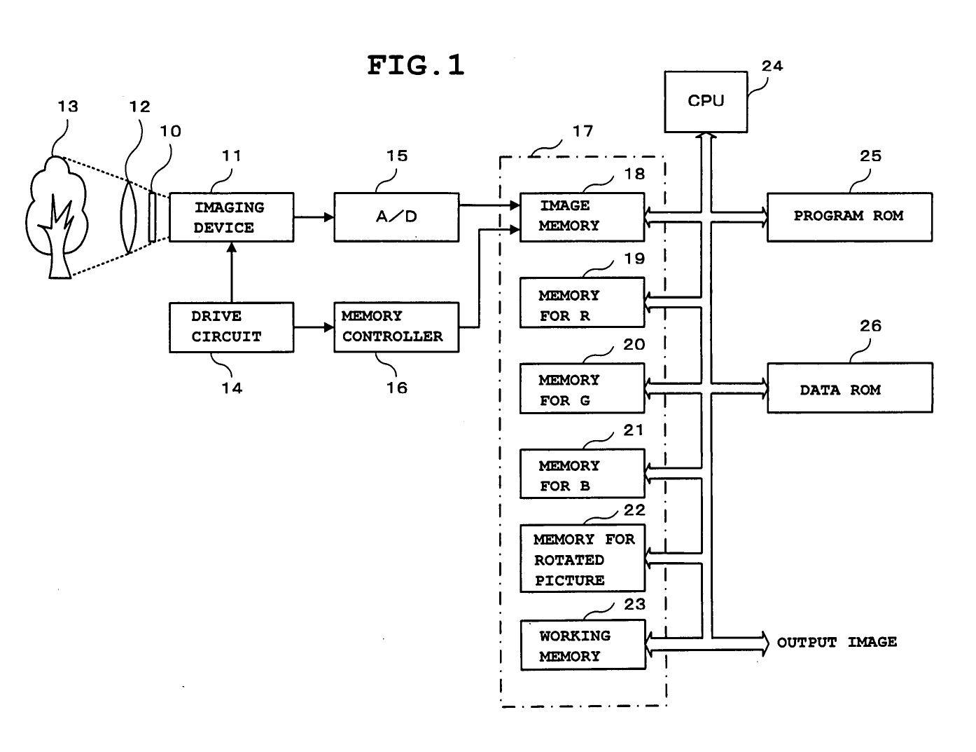

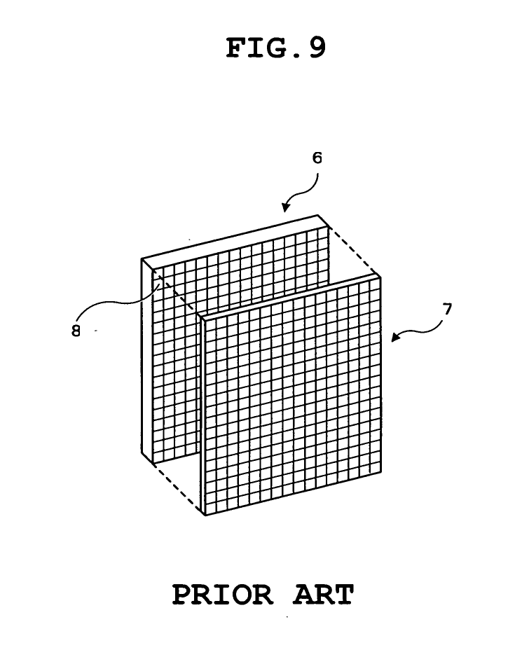

FIG. 1 shows an overall configuration of an embodiment of the present invention. In the diagram, a color imaging device 11 of a single-plate type, which is, for example, configured by a CCD, has a color filter 10 of Bayer type (see the color filter 7 of FIG. 9) attached to an imaging face thereof. The single-plate type color imaging device 11 converts an image of a subject 13 inputted via an optical system 12 such as an image pickup lens to an electrical signal and outputs it. Drive of the color imaging device is performed by a drive circuit 14. The electrical signal outputted from the color imaging device 11 is converted to a digital signal by an A/D converter 15, and is subsequently stored in an image memory 18 in a memory section 17 under the control of a memory controller 16.

The memory section 17 further includes a memory exclusively for a red color (hereinafter referred to as memory for R) 19, a memory exclusively for a green color (hereinafter referred to as memory for G) 20, a memory exclusively for a blue color (hereinafter referred to as memory for B), a memory for rotated picture 22 and a working memory 23. Inputting and outputting of these memories 18 to 23 are controlled by a CPU 24.

While controlling inputting and outputting of data among an image memory 10, the memory for R 19, the memory for G 20, the memory for B 21, and the working memory 23 in accordance with a processing program which has been stored in advance in a program ROM 25, the CPU 24 sequentially reads out each of the three primary-color images of light (an image R, an image G and a image B), and develops these images to the memory for R 19, the memory for G, and the memory for B. In addition, the CPU 24 performs required image processing such as optical flow estimation as described at the beginning herein, tracking processing and generation processing of a synthesized image (i.e., a synthesized image produced by overlapping a plurality of images that are shot of a same subject consecutively).

Note that a data ROM 26 retains pixel arrangement information of the color filter 10, and the CPU 24 accesses the information to utilize it appropriately.

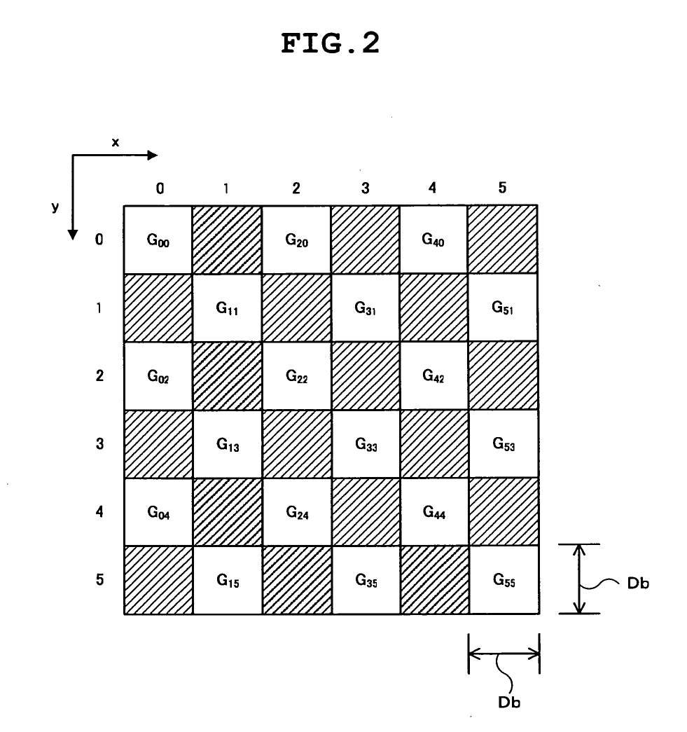

FIG. 2 is a schematic view of the image G developed in the memory G. In the drawing, when it is assumed that a horizontal (line) direction is the x-axis and a vertical (column) direction is they-axis, information pixel of the subject can be expressed as G_{xy}. As described before, an image shot by an imaging device of Bayer type contains one information missing pixel (a hatched pixel in FIG. 2) between the two information pixels G_{xy}. Accordingly, the information pixels G_{xy} are arranged in every other cell in both the line direction and the column direction. In other words, an effective pixel pitch in the vertical direction or the horizontal direction is 2 Db.

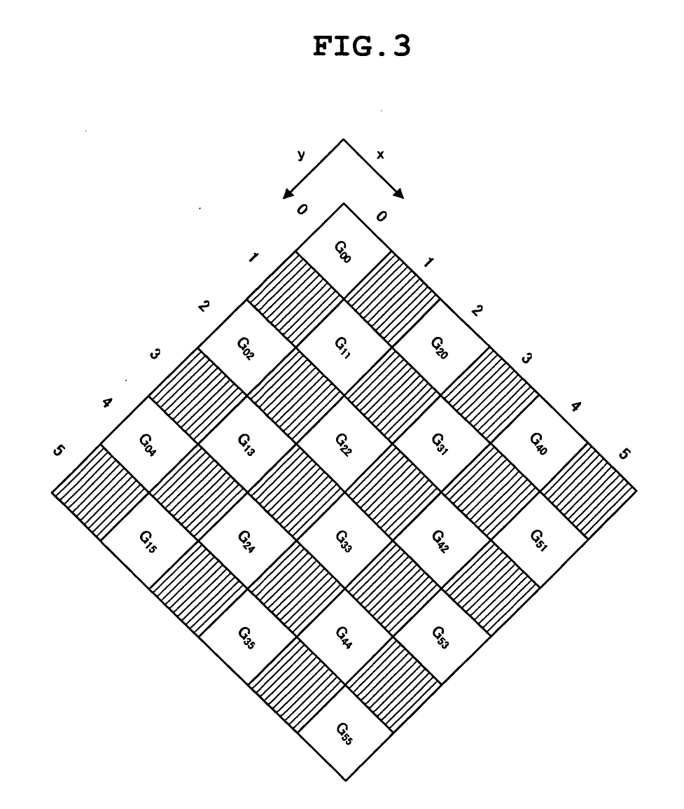

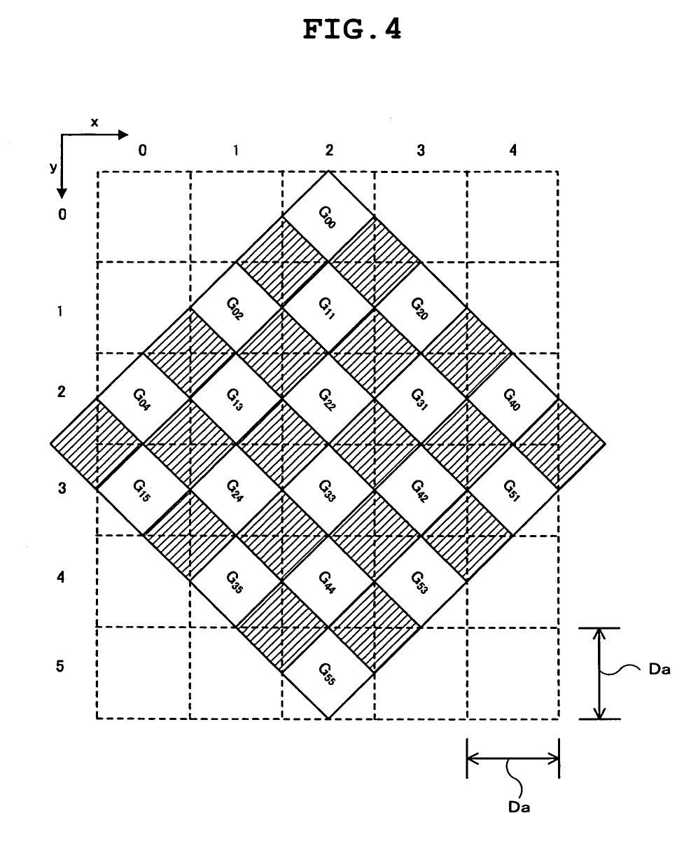

FIG. 3 is a diagram of a rotated picture generated by rotating the image G by 45 degrees in a predetermined direction (clockwise in the diagram); and FIG. 4 is a diagram of the rotated picture overlapped with coordinate axes before rotation. A grid shown by dotted lines in FIG. 4 represents each pixel based on the coordinate axes before rotation, each of the vertical and horizontal pitches Da of the grid is √2 times of a pitch Db between individual pixels based on the coordinate axes before rotation (See FIG. 2.). In this state, effective pixels always exist either in the vertical direction or the horizontal direction. Accordingly, the effective pixel pitch thereof is 1/√2 times compared to 2 DB which is the value before rotation, which enables improved accuracy in optical flow estimation and tracking.

When each pixel based on the coordinate axes before rotation is overlapped with the information pixel G_{xy} of the rotated picture, as shown in FIG. 4, each pixel based on the coordinate axes before rotation contains the information pixels G_{xy}. Specifically, the information pixel G₀₀ is located at x=2, y=0, the information pixel G₀₂ is located at x=1, y=1, the information pixel G₁₁ is located at x=2, y=1, the information pixel G₂₀ is located at x=3, y=1, the information pixel G₀₄ is located at x=0, y=2, the information pixel G₁₃ is located at x=1, y=2, the information pixel G₂₂ is located at x=2, y=2, the information pixel G₃₁ is located at x=3, y=2, the information pixel G₄₀ is located at x=4, y=2, the information pixel G₁₅ is located at x=0, y=3, the information pixel G₂₄ is located at x=1, y=3, the information pixel G₃₃ is located at x=2, y=3, the information pixel G₄₂ is located at x=3, y=3, the information pixel G₅₁ is located at x=4, y=3, the information pixel G₃₅ is located at x=1, y=4, the information pixel G₄₄ is located at x=2, y=4, the information pixel G₅₃ is located at x=3, y=4 and the information pixel G₅₅ is located at x=2, y=5.

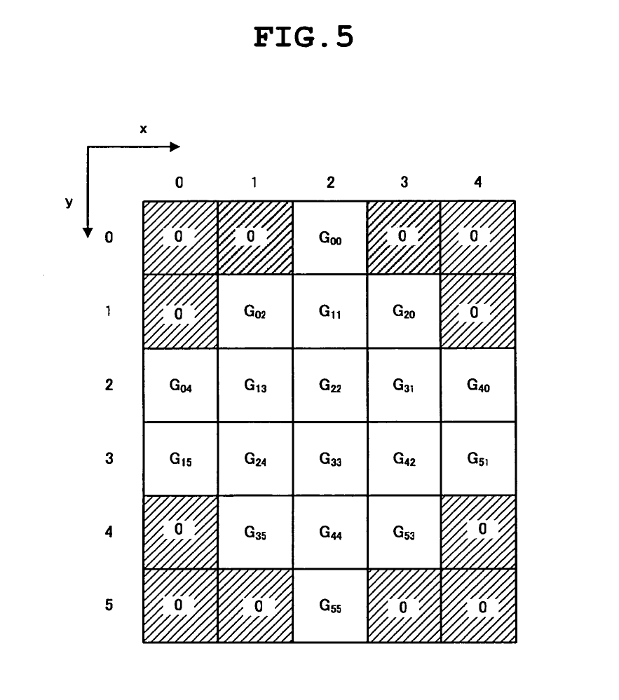

FIG. 5 is a schematic view of the rotated picture stored in the memory for rotated picture 22, and the information pixels G₀₀ to G₅₅ have been sorted out in accordance with the coordination axes of FIG. 4. Specifically, G₀₀ is rearranged at the position of x=2, y=0, G₀₂ is rearranged at the position of x=1, y=1, G₁₁ is rearranged at the position of x=2, y=1, G₂₀ is rearranged at the position of x=3, y=1, G₀₄ is rearranged at the position of x=0, y=2, G₁₃ is rearranged at the position of x=1, y=2, G₂₂ is rearranged at the position of x=2, y=2, G₃₁ is rearranged at the position of x=3, y=2, G₄₀ is rearranged at the position of x=4, y=2, G₁₅ is rearranged at the position of x=0, y=3, G₂₄ is rearranged at the position of x=1, y=3, G₃₃ is rearranged at the position of x=2, y=3, G₄₂ is rearranged at the position of x=3, y=3, G₅₁ is rearranged at the position of x=4, y=3, G₃₅ is rearranged at the position of x=1, y=4, G₄₄ is rearranged at the position of x=2, y=4, G₅₃ is rearranged at the position of x=3, y=4 and G₅₅ is rearranged at the position of x=2, y=5.

In the rotated picture as shown, pixels that do not correspond to the information pixels G₀₀ to G₅₅ (the hatched pixels) store a tentative pixel value “0” which corresponds to a black level.

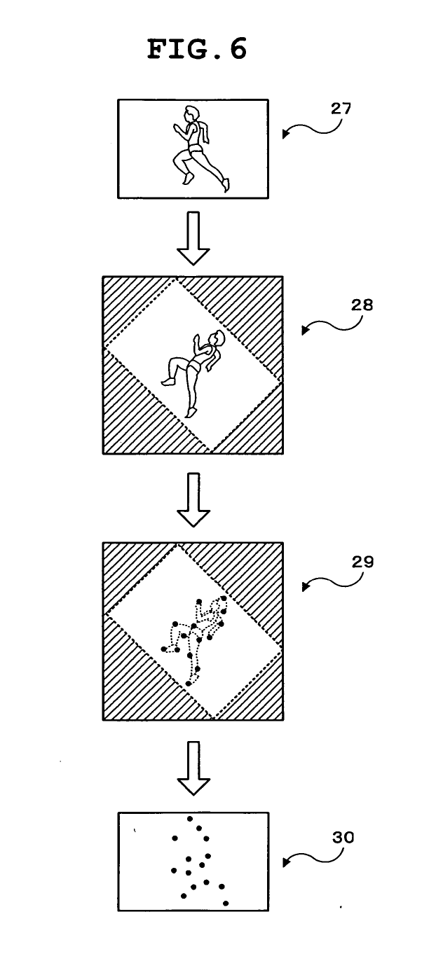

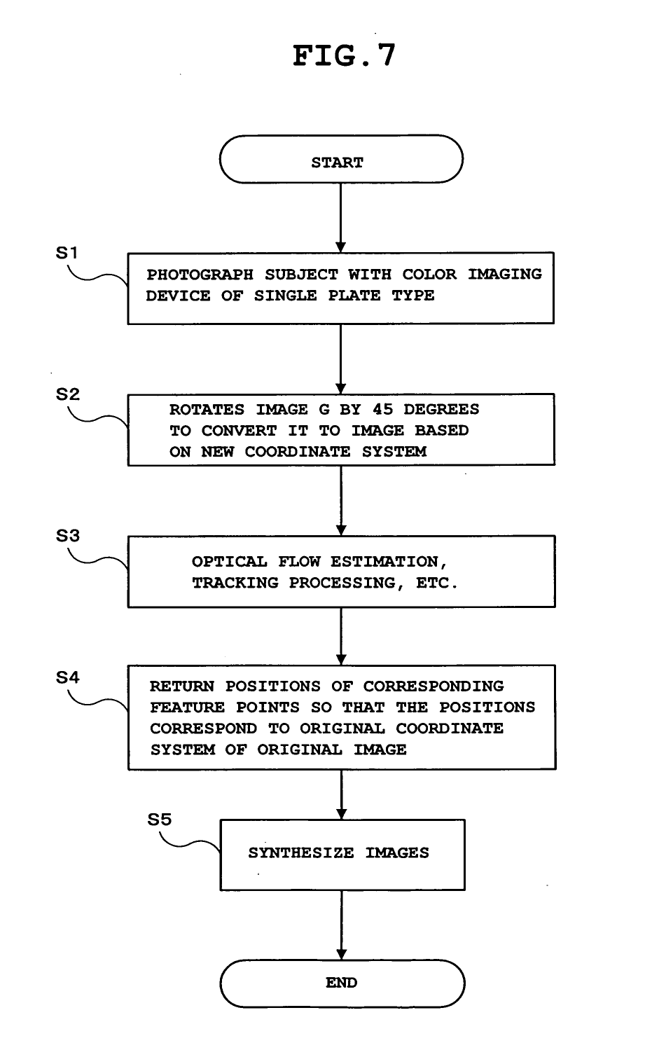

FIG. 6 is a conceptual diagram of optical flow estimation for the rotated picture, and FIG. 7 is a diagram of an operation flowchart including the optical flow estimation processing. In these diagrams, an image G 27 which is shot by the single-plate type color imaging device 11 and developed to the memory G 20 is stored in the memory for rotated picture 22 as a rotated picture 28 which is generated by being rotated by 45 degrees in a certain direction (clockwise in this case). As is the case with the rotated picture shown in FIG. 5, the rotated picture 28 is generated by coordinate transformation of the image G 27 after excluding the information missing pixel therefrom. A feature-point extracted image 29 is an image containing feature points (black circled points) that are read out from the rotated picture 28 according to the optical flow estimation. The feature-point extracted image 29 is rotated by 45 degrees in the reverse direction (counter-clockwise in this case) so that the image finally corresponds to the coordinate system of the original image G 27, and is made to a feature-point extracted image 30 based on the original coordinate system.

As described above, the operation according to the present embodiment shoots a subject with the color imaging device 11 of a single-plate type (Step S1), rotates the shot image G 27 by 45 degrees to convert it to an image (rotated picture 28) based on a new coordinate system (Step S2), performs optical flow estimation, tracking processing or the like of the rotated picture 28 to generate the feature-point extracted image 29 (Step S3), returns the positions of the corresponding feature points of the feature-point extracted image 29 to the original coordinate system to generate the feature-point extracted image 30 which corresponds to the coordinate system of the original pixel (image G 27) (Step S4), and performs image synthesis processing based on the information of the feature-point extracted image 30 (Step S5).

Therefore, on the occasion of optical flow estimation and tracking processing in Step S3, the processing only for pixels G which do not contain the information missing pixels is attained.

Accordingly, this eliminates the need for interpolation processing of the information missing pixels, thereby reducing load which would correspond to a conventional interpolation processing. In addition, in the case where the original Bayer array shown in FIG. 2 is accessed diagonally, since a discontinuous address is referred to for each pixel, a phenomenon of speed deterioration in reading out from the RAM occurs. In the present embodiment, however, due to the 45-degree rotation processing, the RAM is sequentially accessed, whereby the maximum RAM access speed can be maintained. These arrangements enhance an operational speed of the optical flow estimation and the tracking processing, and enable avoiding problems such as, for example, decrease in the number of shootings during the consecutive speed shooting.

While the present invention has been described with reference to the preferred embodiments, it is intended that the invention be not limited by any of the details of the description therein but includes all the embodiments which fall within the scope of the appended claims.

What is claimed is:

1. An image processing apparatus comprising:
an image read section for reading an image produced by a color imaging device;
a first coordinate transformation section for rotating the image read by the image read section by 45 degrees in a predetermined direction to generate a rotated picture based on a new coordinate system;
an image processing section for performing image processing of the rotated picture; and
a second coordinate transformation section for rotating the image after the image processing by 45 degrees in the reverse direction of the predetermined direction to reflect the image processing to the image in the original coordinate system.

2. The image processing apparatus according to claim 1, wherein the image read section reads a signal G of Bayer array.

3. The image processing apparatus according to claim 1, wherein the image processing performed by the image processing section includes optical flow estimation processing between a plurality of images that are shot of a same subject consecutively with the color imaging device.

4. An image processing method comprising the steps of:
an image read step for picking up an image produced by a color imaging device,
a first coordinate transformation step for rotating the image read by the image read step by 45 degrees in a predetermined direction to generate a rotated picture based on a new coordinate system;
an image processing step for performing image processing to the rotated picture; and
a second coordinate transformation step for rotating the image after the image processing by 45 degrees in the reverse direction of the predetermined direction to reflect the image processing to the image in the original coordinate system.

5. The image processing method according to claim 4, wherein the image read step reads a signal G of Bayer array.

6. The image processing method according to claim 4, wherein the image processing performed by the image processing step comprises optical flow estimation processing between a plurality of images that are shot of a same subject consecutively with the color imaging device.
